(19) United States
(12) Patent Application Publication
(10) Pub. No.: US 2021/0394275 A1
(43) Pub. Date: Dec. 23, 2021

(54) MACHINING METHOD AND MACHINING APPARATUS

(71) Applicant: National University Corporation Tokai National Higher Education and Research System, Nagoya-shi (JP)

(72) Inventor: Eiji Shamoto, Nagoya-shi (JP)

(21) Appl. No.: 17/463,791

(22) Filed: Sep. 1, 2021

Related U.S. Application Data
(63) Continuation of application No. PCT/JP2019/008295, filed on Mar. 4, 2019.

(51) Int. Cl. B23B 1/00; B23B 27/02; B23Q 5/22; B23Q 15/00

(52) U.S. Cl. CPC B23B 1/00; B23Q 15/00; B23Q 5/22; B23B 27/02

(57) ABSTRACT

A machining apparatus machines a surface of a workpiece by feeding, relative to the workpiece, a cutting tool having a plurality of cutting edges A to D with tips of the cutting edges A to D arranged at equal intervals. The machining apparatus performs a cutting process of cutting the surface of the workpiece with the plurality of cutting edges A to D and a feeding process of feeding the cutting tool relative to the workpiece by a predetermined feed amount to form a plurality of grooves on the surface of the workpiece. The predetermined feed amount is set to a length that is not an integral multiple of the interval between the tips of cutting edges.

### CROSS REFERENCE TO RELATED APPLICATIONS

This application is based upon and claims the benefit of priority from International Application No. PCT/JP2019/008295, filed on Mar. 4, 2019, the entire contents of which are incorporated herein by reference.

### BACKGROUND

### 1. Field of the Disclosure

The present disclosure relates to a technique of machining a workpiece with a cutting tool having a plurality of cutting edges arranged side by side.

### 2. Description of the Related Art

A periodic microstructure in which projections and depressions are formed on a metal surface with a pitch of submicron to micron order has received a lot of attention. “Diamond turning of high-precision roll-to-roll imprinting molds for fabricating subwavelength gratings”, Chun-Wei Liu, Jiwang Yan, and Shih-Chieh Lin, Optical Engineering 55(6), 064105, June 2016 discloses periodic fine grooves that are made by using a monocrystalline diamond tool having a single point sharply ground to transfer the point shape to hard copper at a pick feed of submicron order. “Fabrication of periodic nanostructures by single-point diamond turning with focused ion beam built tool tips”, J. Sun, et al., Journal of micromechanics and microengineering. 22 (2012) 115014 (11 pp) discloses a technique of cutting a surface of a workpiece with four fine protrusions (cutting edges) that are periodically formed on a monocrystalline diamond tool using a focused ion beam.

Since the tool disclosed in “Diamond turning of high-precision roll-to-roll imprinting molds for fabricating subwavelength gratings” has only a single point, machining efficiency of creating periodic fine grooves is low. Since the monocrystalline diamond tool disclosed “Fabrication of periodic nanostructures by single-point diamond turning with focused ion beam built tool tips” has four periodic cutting edges, setting the pick feed to a length equivalent to four pitches allows periodic fine grooves to be created with machining efficiency four times higher than a single cutting edge. In order to form a periodic microstructure by such cutting process, it is preferable to use a cutting tool having a plurality of periodic cutting edges.

The use of the focused ion beam as disclosed in “Fabrication of periodic nanostructures by single-point diamond turning with focused ion beam built tool tips” allows periodic cutting edges to be formed at micron-order intervals, but leads to an increase in manufacturing cost of the tool. It is therefore desirable to come up with a technique of forming fine grooves with a pitch of micron order or less using a plurality of cutting edges arranged at intervals larger than micron order.

### SUMMARY

The present disclosure has been made in view of such circumstances, and it is therefore an object of the present disclosure to provide a technique of forming, using a cutting tool having cutting edges periodically provided, grooves with a pitch smaller than an interval between the cutting edges. This technique is applicable to a case where the above-described periodic microstructure is formed and is further applicable to a case where grooves parallel to each other are simply formed with a pitch smaller than the interval between the cutting edges.

In order to solve the above-described problems, an aspect of the present disclosure relates to a machining method for machining a workpiece with a cutting tool having a plurality of cutting edges with tips of the cutting edges arranged at equal intervals. Under this method, a cutting process of cutting a surface of a workpiece with a plurality of cutting edges and a feeding process of feeding the cutting tool relative to the workpiece by a predetermined feed amount are performed to form a plurality of grooves on the surface of the workpiece. The predetermined feed amount is set to a length that is not an integral multiple of the interval between the tips of cutting edges.

Another aspect of the present disclosure relates to a machining apparatus that machines a surface of a workpiece by feeding, relative to the workpiece, a cutting tool having a plurality of cutting edges with tips of the cutting edges arranged at equal intervals. This machining apparatus performs a cutting process of cutting a surface of a workpiece with a plurality of cutting edges and a feeding process of feeding the cutting tool relative to the workpiece by a predetermined feed amount to form a plurality of grooves on the surface of the workpiece. The predetermined feed amount is set to a length that is not an integral multiple of the interval between the tips of cutting edges.

Yet another aspect of the present disclosure relates to a cutting condition generator that calculates a feed amount of a cutting tool having a plurality of cutting edges with tips of the cutting edges arranged at equal intervals. This cutting condition generator includes an acquirer that receives an interval p between the tips of the cutting edges of the cutting tool, the number of cutting edges N of the cutting tool, and a groove pitch Δp with which grooves are formed on a surface of a workpiece, and a setter that sets a feed amount based on the interval p, the number of cutting edges N, and the groove pitch Δp smaller than the interval p.

### BRIEF DESCRIPTION OF THE DRAWINGS

FIG. 1 is a diagram showing a schematic structure of a machining apparatus according to an embodiment;

FIG. 2 is a diagram showing a structure of a tool tip of a cutting tool;

FIG. 3 is a diagram showing a procedure of forming a periodic microstructure with the cutting tool;

FIGS. 4A, 4B, 4C, 4D, 4E, 4F, 4G, 4H, and 4I are diagrams for describing a state of a machined surface of a workpiece; and

FIG. 5 is a diagram showing how a fine groove is formed on a freeform surface.

### DETAILED DESCRIPTION

The disclosure will now be described by reference to the preferred embodiments. This does not intend to limit the scope of the present disclosure, but to exemplify the disclosure.

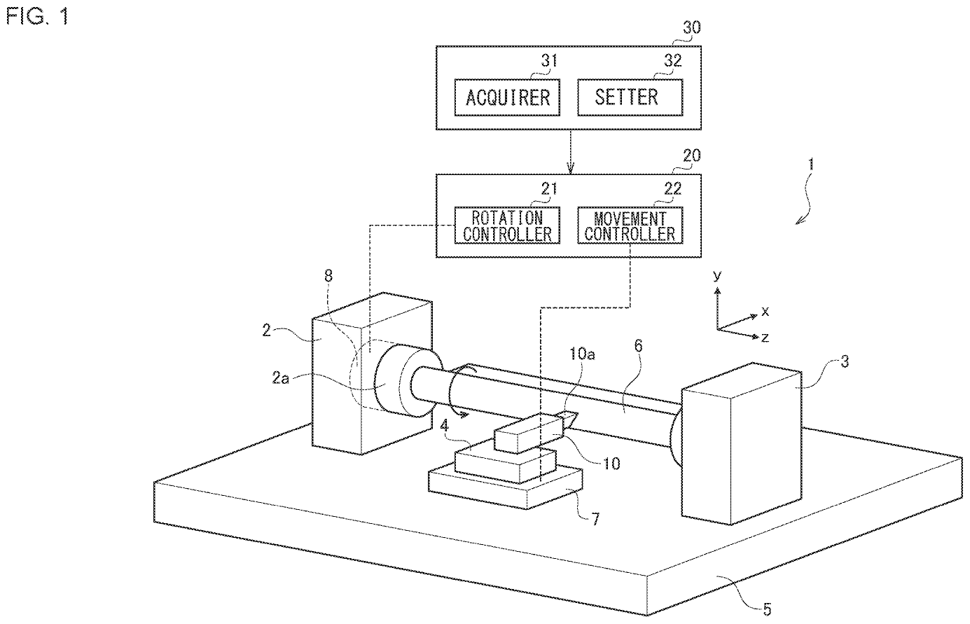

FIG. 1 is a diagram showing a schematic structure of a machining apparatus 1 according to an embodiment. The machining apparatus 1 is a cutting apparatus that brings a tool tip 10a of a cutting tool 10 into contact with a workpiece 6 to turn the workpiece 6. Note that the machining apparatus 1 may be a cutting apparatus that performs milling process. The tool tip 10a of the cutting tool 10 has a plurality of cutting edges with tips of the cutting edges arranged at equal intervals and cuts the workpiece 6 with the plurality of cutting edges at a time. The machining apparatus 1 includes, on a bed 5, a headstock 2 and a tailstock 3 that support the workpiece 6 rotatable and a tool post 4 that supports the cutting tool 10.

A rotation mechanism 8 is provided inside the headstock 2 and rotates a spindle 2a to which the workpiece 6 is attached. A feed mechanism 7 is provided on the bed 5 and moves the cutting tool 10 relative to the workpiece 6. In this machining apparatus 1, the feed mechanism 7 moves the tool post 4 in X-axis, Y-axis, and Z-axis directions to move the cutting tool 10 relative to the workpiece 6. Herein, the X-axis direction is a horizontal direction and depth-of-cut direction orthogonal to an axis of the workpiece 6, the Y-axis direction is a cutting direction that coincides with a vertical direction, and the Z-axis direction is a feed direction parallel to the axis of the workpiece 6.

A controller 20 includes a rotation controller 21 that controls rotation of the spindle 2a by the rotation mechanism 8, and a movement controller 22 that causes the feed mechanism 7 to bring the tool tip 10a into contact with the workpiece 6 to machine the workpiece 6 with the cutting tool 10 while the spindle 2a is rotating. The rotation mechanism 8 and the feed mechanism 7 each include a drive unit such as a motor, and the rotation controller 21 and the movement controller 22 each regulate power to be supplied to a corresponding drive unit to control behavior of a corresponding one of the rotation mechanism 8 and the feed mechanism 7.

A cutting condition generator 30 generates, based on information input by an operator or the like, a cutting condition to be used by the controller 20. The cutting condition generator 30 includes an acquirer 31 that receives information on cutting and a setter 32 that sets the cutting condition based on the information thus received. The acquirer 31 receives the information input by the operator and retrieves a tool specification from a tool master table or the like. The machining apparatus 1 may be an NC machine tool, and the cutting condition generator 30 may generate NC data to be applied to the NC machine tool and provide the NC data to the controller 20. The cutting condition generator 30 may be a part of the machining apparatus 1 or may be provided as a separate entity.

Note that, in the machining apparatus 1 according to the embodiment, the workpiece 6 is attached to the spindle 2a and is rotated by the rotation mechanism 8. Alternatively, the cutting tool 10 may be attached to the spindle 2a and be rotated by the rotation mechanism 8. Further, the feed mechanism 7 only needs to move the cutting tool 10 relative to the workpiece 6 and may be structured to move at least either the cutting tool 10 or the workpiece 6.

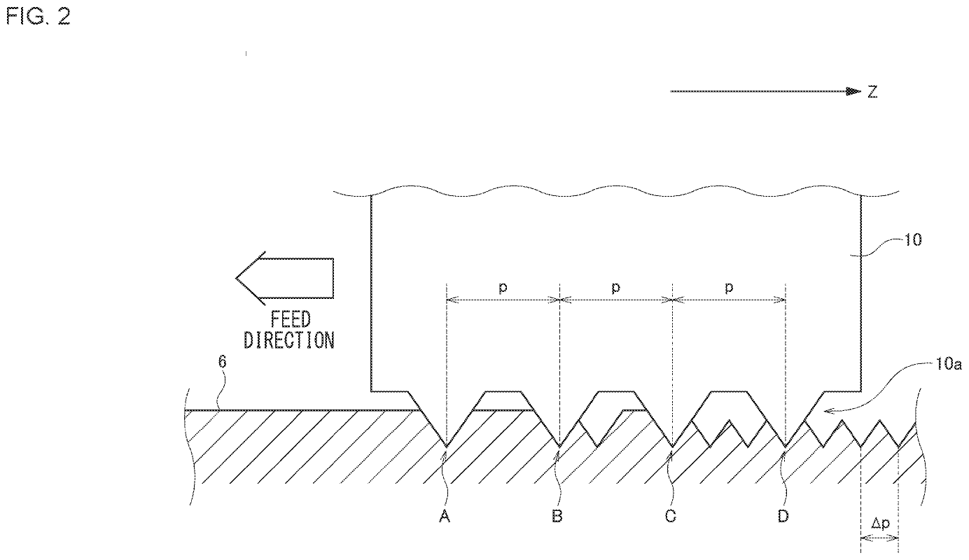

FIG. 2 shows a structure of the tool tip 10a of the cutting tool 10. A plurality of cutting edges A, B, C, D are provided on the tool tip 10a and have their respective tips arranged at equal intervals. Hereinafter, the interval between the tips of cutting edges is denoted by “p”, and the number of cutting edges is denoted by “N”. The tip of each cutting edge may be made of, for example, a diamond-coated layer, a monocrystalline diamond, a CBN, a polycrystalline diamond, a nano-polycrystalline diamond, or the like. The surface of the workpiece 6 may be a surface extending linearly in the feed direction, that is, a flat surface, a cylindrical surface or a conical surface that is curved in the cutting direction orthogonal to the paper surface, another curved surface, or a curved surface that is approximately flat in the feed direction.

The machining apparatus 1 according to the embodiment performs a cutting process of cutting the surface of the workpiece 6 with the plurality of cutting edges A to D and a feeding process of feeding the cutting tool 10 relative the workpiece 6 by a predetermined feed amount to form a plurality of grooves on the surface of the workpiece 6. As described below, the machining apparatus 1 forms a plurality of grooves with a groove pitch Δp smaller than the interval p between the tips of the cutting edges.

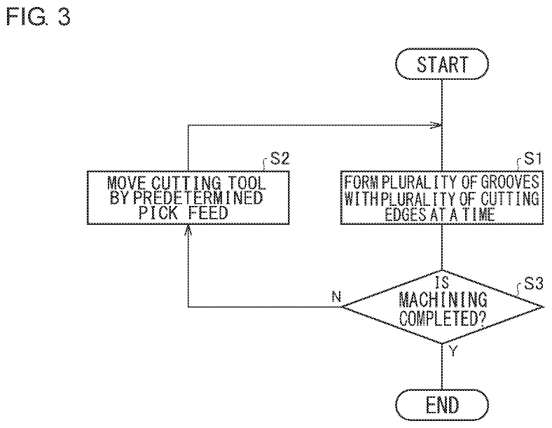

FIG. 3 shows a procedure of forming a periodic microstructure with the cutting tool having the plurality of cutting edges arranged side by side. The movement controller 22 controls the feed mechanism 7 to move the cutting tool 10 relative to the workpiece 6. The movement controller 22 alternately repeats a cutting process (S1) of causing at least one of the cutting edges A to D to cut into the workpiece 6 to cut the surface of the workpiece 6 and a feeding process (S2) of feeding the cutting tool 10 relative to the workpiece 6 by the predetermined feed amount (pick feed) in the feed direction (Z-axis direction) orthogonal to the cutting direction (X-axis direction) to form a plurality of grooves parallel to each other on the surface of the workpiece 6. Note that the feed direction is not necessarily orthogonal to the cutting direction, and the parallelism of the plurality of grooves may include an approximately parallel state without departing from the purpose of realizing the periodic microstructure.

During the cutting process, the movement controller 22 causes the cutting edges A to D to gradually cut into the workpiece 6, stops the cutting edges A to D at a predetermined depth and keeps the cutting edges A to D stationary until the workpiece 6 rotates one or more turns, and then moves the cutting edges A to D away from the workpiece 6. Subsequently, the movement controller 22 performs the feeding process of feeding the cutting tool 10 relative to the workpiece 6 by a predetermined pick feed and performs the cutting process again. During the feeding process, the workpiece 6 may keep rotating or be at rest.

The cutting process (S1) and the feeding process (S2) are repeatedly performed until a groove structure is formed in which a plurality of grooves are periodically arranged with a groove pitch Δp of micron order or less (N in S3), and when a periodic microstructure is formed (Y in S3), the cutting process by the cutting tool 10 is terminated. The movement control by the movement controller 22 is executed based on the cutting condition generated by the cutting condition generator 30.

Before the start of machining, the operator enters, into the cutting condition generator 30, the groove pitch Δp with which grooves are formed on the surface of the workpiece 6. Upon receipt of the groove pitch Δp, the acquirer 31 retrieves, from a tool DB (not shown), specification information on a cutting tool capable of forming grooves with the groove pitch Δp. In order to form a periodic microstructure on the workpiece 6, the acquirer 31 specifies a cutting tool having an interval p between tips of cutting edges that is q times the groove pitch Δp (q is an integer equal to or greater than 2) as a cutting tool capable of forming grooves with the groove pitch Δp. For example, the tool DB may hold options regarding applicable groove pitches for each cutting tool, and the acquirer 31 may consult information on the options to specify a cutting tool capable of forming grooves with the groove pitch Δp. After specifying the cutting tool, the acquirer 31 reads specification information containing at least the interval p between the tips of cutting edges and the number of cutting edges N. The setter 32 sets a pick feed f, which is a feed amount, based on the interval p between the tips of cutting edges, the number of cutting edges N, the groove pitch Δp smaller than the interval p.

When the pick feed is an integral multiple of the interval p between the tips of cutting edges, the groove pitch Δp is an integral multiple (one time) of the interval p and is not smaller than the interval p. Therefore, the setter 32 sets the pick feed f to a length that is not an integral multiple of the interval p. That is, the setter 32 sets the pick feed f to satisfy the following:

pick feed f≠cutting edge interval p*S (S is an integer).

Further, the setter 32 sets the pick feed f to m times the groove pitch Δp (m is an integer equal to or greater than 2) in order to transfer the periodic microstructure with the groove pitch Δp to the workpiece 6 by cutting process with the pick feed f constant. This results in pick feed f=m*Δp

where, since p=q*Δp is satisfied, and the pick feed f is set to a length that is not an integral multiple of the interval p, m is a value that is not an integral multiple of q. As will be described later, the number of cutting edges N is preferably equal to or greater than m.

A description will be given of the machining procedure under the following cutting conditions:

the number of cutting edges N is equal to 4,

the groove pitch Δp is equal to p/3 (q is equal to 3), and

the pick feed f is equal to 4*Δp (m is equal to 4).

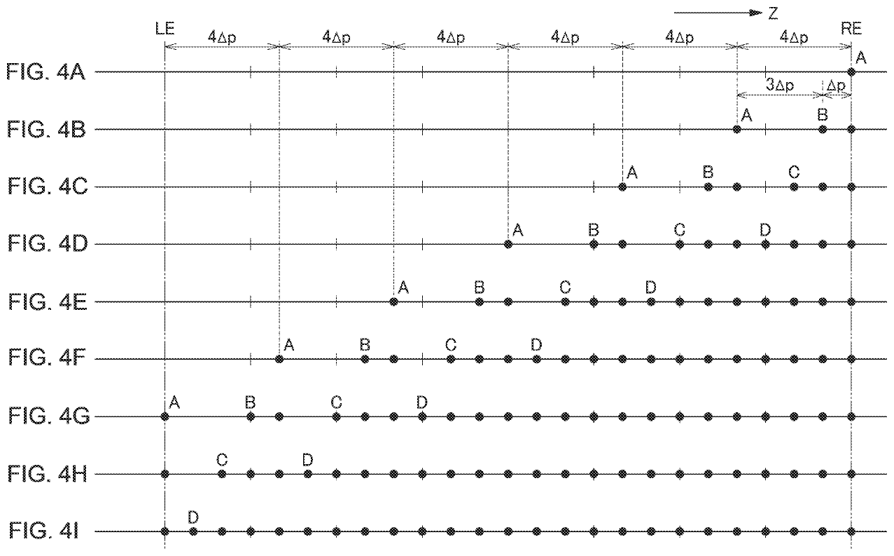

FIGS. 4A to 4I are diagrams for describing a machining state of the surface of the workpiece 6. The diagrams given for description show a process of forming a plurality of grooves with the groove pitch Δp in a cutting range extending from a right position RE to a left position LE on the surface of the workpiece. In FIGS. 4A to 4I, the grooves are formed in the workpiece 6 using the cutting tool 10 having the cutting edges A, B, C, D arranged in this order from the left. The interval p between the cutting edges is 3Δp. Each black circle indicates a position of a cut groove, and A to D on the black circles indicate cutting edges for use in cutting.

FIG. 4A shows a state where the cutting edge A cuts the position RE that is the right end of the cutting range.

FIG. 4B shows a state where the cutting edges A, B cut the workpiece 6 after the cutting tool 10 is moved in the −Z direction by the pick feed f. As described above, the pick feed f is 4Δp, and the interval p between the tips of cutting edges is 3Δp. If the pick feed f is set to an integral multiple of the interval p, the groove pitch will be equal to the interval p, which prevents Δp from being smaller than the interval p (equal to p/3). Therefore, the setter 32 sets the pick feed f to a length that is not an integral multiple of the interval p between the tips of cutting edges, which allows the groove pitch Δp to be smaller than the interval p. In terms of a relation between m and q, m is set to an integer that is equal to or greater than 2 and is not an integral multiple of q.

FIG. 4C shows a state where the cutting edges A, B, C cut the workpiece 6 after the cutting tool 10 is further moved in the −Z direction by the pick feed f.

FIG. 4D shows a state where the cutting edges A, B, C, D cut the workpiece 6 after the cutting tool 10 is further moved in the −Z direction by the pick feed f. In this state, all the cutting edges A to D cut the cutting range of the workpiece 6.

FIGS. 4E to 4G show a state where the cutting edges A to D cut the workpiece 6. In FIG. 4G, the cutting edge A cuts the position LE that is the left end of the cutting range.

FIG. 4H shows a state where the cutting edges C, D cut the workpiece 6, and FIG. 4I shows a state where the cutting edge D cuts the workpiece 6.

As shown in FIGS. 4A to 4I, the machining apparatus 1 moves the cutting tool 10 by the predetermined pick feed f to form a periodic microstructure with the groove pitch Δp on the surface of the workpiece 6.

According to the embodiment, the cutting tool 10 having the number of cutting edges N equal to or greater than m is used. In the example shown in FIGS. 4A to 4I, the number of cutting edges N is equal to m. If the number of cutting edges N is less than m, as shown in FIGS. 4A to 4I, grooves corresponding to (N−m) cutting edges will not be formed. For example, when the number of cutting edges N is three without the cutting edge D, the grooves formed by the cutting edge D shown in FIGS. 4A to 4I do not exist, and a periodic structure is not formed accordingly. It is therefore required that the number of cutting edges N be equal to or greater than m.

On the other hand, when the number of cutting edges N is greater than m, the grooves already formed shown in FIGS. 4A to 4I are cut by another cutting edge. For example, in the example of FIGS. 4A to 4I, when there is a fifth cutting edge E, the cutting edge E cuts again the grooves formed by the cutting edge A and does not form a new groove. Therefore, the structure where the number of cutting edges N is equal to m prevents a plurality of cutting edge from repeatedly cutting the same position and thus allows efficient machining.

A result of consideration of the relation between m and q made by the present discloser shows that making m and q coprime allows a periodic microstructure with the groove pitch Δp to be formed. If m and q have a common divisor CF other than 1, the resultant groove pitch of a periodic structure will be equal to CF*Δp. Therefore, the setter 32 can set the pick feed f for realizing the groove pitch Δp by determining m that is coprime with q.

In the above-described example, in order to form a periodic microstructure on a surface extending linearly or extending approximately linearly in the feeding direction, a line connecting the tips of the plurality of cutting edges A to D preferably extends linearly. On the other hand, when an intended machined surface is curved in the feed direction, a cutting tool 10 having a line connecting the tips of the plurality of cutting edges extending arcuately may be used. For example, when a fine groove surface is formed on a freeform surface, the movement controller 22 rotates the cutting tool 10 about the cutting direction to control the position of the cutting tool 10 so as to make the line connecting the tips of the plurality of cutting edges approximately parallel to the freeform surface to be cut, and applies the pick feed f along the intended machined surface. In this case, it is required that the machined surface be close in curvature to the line connecting the tips of the plurality of cutting edges, and a deviation in the cutting depth direction with respect to a cutting edge width w be smaller than a depth of grooves to be formed. When Rt denotes a radius of an arc connecting the tips of the plurality of cutting edges, and Rw denotes an intended radius of curvature at a machining position of the freeform surface, a deviation ε is approximately derived from the following equation:

$$ɛ \approx \frac{{w}^{2}}{8} ( \frac{1}{{R}_{t}} - \frac{1}{{R}_{w}} ) \qquad [ Math . 1 ]$$

For example, when p is 5 μm, Δp is 250 nm, f is 5.25 μm (m is 21), N is 21, w is N*Δp, Rt is 1 mm, and Rw is 100 mm,

ε is calculated to be 0.0034 μm. This deviation is small enough with respect to an ultrafine groove shape of submicron order. Further, as compared with a machining method using a single cutting edge (pick feed f is 250 nm and is equal to Δp) in the related art, machining efficiency of 21 times (5.25 μm/250 nm) can be achieved.

In the method for machining the freeform surface described above, the position of the cutting tool 10 is controlled, but in the following machining method, fine grooves are formed without a change in the position of the cutting tool 10.

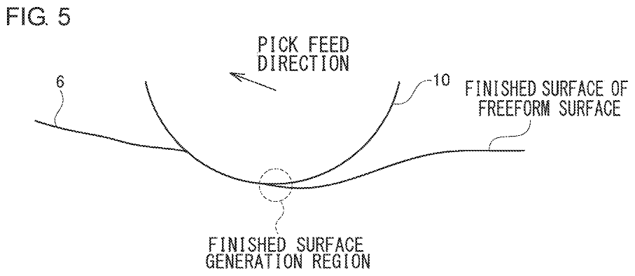

FIG. 5 shows a state where the cutting tool 10 forms a fine groove on the freeform surface. In this machining method, the cutting tool 10 in which an infinite number of fine cutting edges are periodically formed on an arc at intervals p is used. The movement controller 22 sets the pick feed f to m*Δp described above and causes the pick feed direction to coincide with a tangential direction of the freeform surface in a finished surface generation region without a change in rotation angle (position) of the cutting tool 10. This makes the machining of the finished surface generation region similar to the machining described with reference to FIGS. 4A to 4I and allows ultrafine grooves to be formed with the pitch Δp. In this machining method, Rt is designed to satisfy Rt≤Rw.

Employed in the embodiment described above is the machining method where the machining apparatus 1 alternately repeats the cutting process of cutting the surface of the workpiece 6 with the plurality of cutting edges and the feeding process of feeding the cutting tool 10 relative to the workpiece 6 by the predetermined pick feed. Specifically, the machining apparatus 1 intermittently performs the cutting process, and in this sense, the pick feed is a feed amount applied to between each cutting process to be performed intermittently.

Another machining method may be employed where the machining apparatus 1 performs, at the same time, the cutting process of cutting the surface of the workpiece 6 with the plurality of cutting edges and the feeding process of feeding the cutting tool 10 relative to the workpiece 6 by the predetermined feed amount. Referring to FIG. 1, the machining apparatus 1 moves the cutting tool 10 relative to the workpiece 6 in the feed direction by the predetermined feed amount while cutting the cylindrical surface of the workpiece 6 with the plurality of cutting edges. Under this machining method, the cutting process is continuously performed, and a plurality of spiral grooves are formed on the surface of the workpiece 6. When the cutting tool 10 having four cutting edges A to D is used as shown in FIG. 2, four parallel spiral grooves are formed on the surface of the workpiece 6.

Even when this machining method is employed, the feed amount applied to the cutting process to be performed continuously is defined as a feed amount per revolution (μm/rev), and may be set to the value f calculated as the pick feed according to the embodiment. For turning process, setting the feed amount per revolution to the value f allows the periodic microstructure to be formed with high efficiency by continuous machining. Note that the feed amount per revolution may be set to the value f not only for turning process in which a plurality of spiral grooves are continuously formed on a cylindrical surface having a uniform diameter but also for turning process in which a plurality of spiral grooves are continuously formed on a surface that gradually changes in diameter such as a conical surface, a spherical surface, an aspherical surface close to a spherical surface, an end surface (flat surface), or another axisymmetric curved surface.

The present disclosure has been described on the basis of the embodiment. It is to be understood by those skilled in the art that the embodiment is illustrative and that various modifications are possible for a combination of components or processes, and that such modifications are also within the scope of the present disclosure.

For example, when it is required that a fine shape be further formed in the cutting direction, fine groove machining may be performed at the same position with the cutting direction changed by using the above-described procedure or by using a combination of the above-described procedure and the fine machining method disclosed in JP 2017-217720A.

The outline of an aspect of the present disclosure is as follows. Provided according to an aspect of the present disclosure is a machining method for machining a workpiece with a cutting tool having a plurality of cutting edges with tips of the cutting edges arranged at equal intervals, the machining method including a cutting process of cutting a surface of a workpiece with a plurality of cutting edges, and a feeding process of feeding the cutting tool relative to the workpiece by a predetermined feed amount to form a plurality of grooves on the surface of the workpiece. The predetermined feed amount is set to a length that is not an integral multiple of the interval between the tips of cutting edges. Setting the predetermined feed amount to a length that is not an integral multiple of the interval between the tips of cutting edges makes the interval between the grooves to be formed smaller than the interval between the tips of cutting edges.

Under this machining method, grooves parallel to each other may be formed on the surface of the workpiece with a groove pitch Δp that is 1/q times (q is an integer equal to or greater than 2) the interval p between the tips of cutting edges. As a result, even when a plurality of cutting edges cannot be formed on the cutting tool with the pitch Δp, a plurality of grooves can be formed on the workpiece with the pitch Δp.

Under this machining method, the predetermined feed amount may be set to m times the groove pitch Δp (m is an integer equal to or greater than 2). At this time, it is required that m be not an integral multiple of q. Making m and q coprime allows periodic grooves to be formed with the predetermined pick feed. It is preferable to use a cutting tool having the number of cutting edges N equal to or greater than m, and the number of cutting edges N may be equal to m. The predetermined feed amount may be a feed amount applied to between each cutting process to be performed intermittently, or may be a feed amount applied to the cutting process to be performed continuously.

Provided according to another aspect of the present disclosure is a machining apparatus. The machining apparatus is structured to machine a surface of a workpiece by feeding, relative to the workpiece, a cutting tool having a plurality of cutting edges with tips of the cutting edges arranged at equal intervals, and the machining apparatus performs a cutting process of cutting the surface of the workpiece with the plurality of cutting edges and a feeding process of feeding the cutting tool relative the workpiece by a predetermined feed amount to form a plurality of grooves on the surface of the workpiece. The predetermined feed amount may be set to a length that is not an integral multiple of the interval between the tips of cutting edges.

Provided according to yet another aspect of the present disclosure is a cutting condition generator that calculates a feed amount of a cutting tool having a plurality of cutting edges with tips of the cutting edges arranged at equal intervals. The cutting condition generator includes an acquirer that receives an interval p between the tips of the cutting edges of the cutting tool, the number of cutting edges N of the cutting tool, and a groove pitch Δp with which grooves are formed on a surface of a workpiece, and a setter that sets a feed amount based on the interval p, the number of cutting edges N, and the groove pitch Δp smaller than the interval p.

What is claimed is:

1. A machining method for machining a workpiece with a cutting tool to form a machined surface with a curved shape in a feed direction, the cutting tool having a plurality of cutting edges with tips of the cutting edges arranged at equal intervals, the machining method comprising:
cutting a surface of a workpiece with a plurality of cutting edges and feeding the cutting tool relative to the workpiece by a predetermined feed amount, thereby forming a plurality of grooves on the surface of the workpiece with a groove pitch Δp that is 1/q times an interval p between tips of the cutting edges, q denoting an integer equal to or greater than 2, wherein
the predetermined feed amount is set to m times the groove pitch Δp, m denoting an integer equal to or greater than 2, m and q being coprime, and
the cutting tool has N cutting edges, N being equal to or greater than m, and has a line connecting the tips of the plurality of cutting edges extending arcuately.

2. The machining method according to claim 1, wherein
the cutting tool has a radius Rt of the arc connecting the tips of the plurality of cutting edges equal to or less than a curvature radius Rw of a machining position of the workpiece.

3. The machining method according to claim 1, wherein
N denoting the number of cutting edges is equal to m.

4. The machining method according to claim 1, wherein
the predetermined feed amount is a feed amount applied to between each cutting to be performed intermittently.

5. The machining method according to claim 1, wherein
the predetermined feed amount is a feed amount applied to the cutting to be performed continuously.

6. A machining apparatus that machines a workpiece by feeding, relative to the workpiece, a cutting tool to form a machined surface with a curved shape in a feed direction, the cutting tool having a plurality of cutting edges with tips of the cutting edges arranged at equal intervals, wherein
a surface of a workpiece is cut with a plurality of cutting edges,
the cutting tool is fed relative to the workpiece by a predetermined feed amount to form a plurality of grooves on the surface of the workpiece with a groove pitch Δp that is 1/q times an interval p between tips of the cutting edges, q denoting an integer equal to or greater than 2,
the predetermined feed amount is set to m times the groove pitch Δp, m denoting an integer equal to or greater than 2, m and q being coprime, and
the cutting tool has N cutting edges, N being equal to or greater than m, and has a line connecting the tips of the plurality of cutting edges extending arcuately.

7. The machining apparatus according to claim 6, wherein
the cutting tool has a radius Rt of the arc connecting the tips of the plurality of cutting edges equal to or less than a curvature radius Rw of a machining position of the workpiece.

8. The machining apparatus according to claim 6, wherein
N denoting the number of cutting edges is equal to m.
